(19) United States
(12) Patent Application Publication
(10) Pub. No.: US 2005/0172610 A1
(43) Pub. Date: Aug. 11, 2005

(54) Turbojet having two counter-rotatable fans secured to a counter-rotatable low-pressure compressor

(75) Inventors: Jacques Bart, Verrieres-Le-Buisson (FR); Fabienne Lacorre, Vaux Le Penil (FR); Yann Lebret, Maincy (FR); Vanessa Le Rousseau, Creteil (FR); Patrick Morel, Chartrette (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, PARIS (FR)

(21) Appl. No.: 11/054,559

(22) Filed: Feb. 10, 2005

(30) Foreign Application Priority Data
Feb. 11, 2004 (FR) 04 01334

(51) Int. Cl. F02K 3/04

(52) U.S. Cl. 60/226.1

(57) ABSTRACT

The invention relates to a turbojet having two counter-rotatable fans (3, 5) at the front of an intermediate casing (2), said fans being secured to a counter-rotatable low-pressure compressor (7). The blades (14) of the rear fan (5) extend into the by-pass air flow (F2) from a wheel (15) that surrounds the outer rotor (20) of the low-pressure compressor (7). The distance (L) between the blades (10) of the front fan (3) and the blades (14) of the rear fan (5) is not less than twice the length (l) of the projection onto the axis of the cord-line of the blades (10) of the front fan (3).

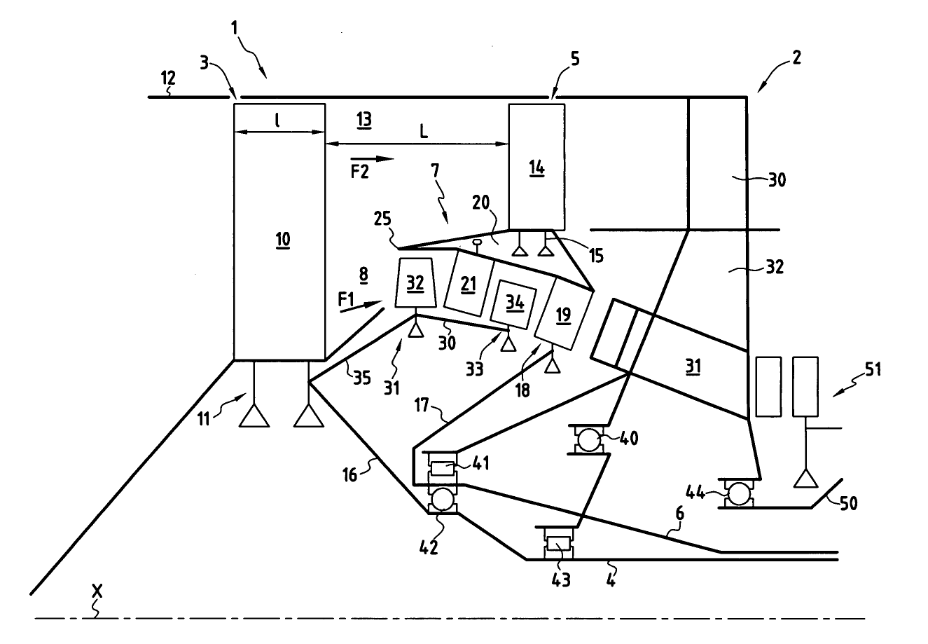

The invention relates to the field of high by-pass ratio turbojets which have two counter-rotatable fans.

More specifically, the invention relates to a three-spool by-pass turbojet with a high by-pass ratio, having a front fan and a rear fan at the front of a first intermediary casing, said fans having blades that extend radially outwards to the fan casing defining the outside of the by-pass air flow, and also a low-pressure compressor for compressing the air coming into the channel for the main air flow, said front fan and said rear fan being rotated directly, and separately, by two counter-rotatable shafts that are coaxial, and said low-pressure compressor having two sets of counter-rotatable blade rings that are also driven by said shafts.

### BACKGROUND OF THE INVENTION

In high-power turbojets that have a single, large-diameter fan, the peripheral speed at the tips of the blades must be lower than the speed of sound in order to prevent loud and undesirable noise, which reduces aerodynamic efficiency.

It is possible to reduce the speed at the periphery of the blades by interposing speed-reducing gearing between the rotor of the fan and the drive shaft. Nevertheless, gearing and its corresponding accessories make the engine more complicated and heavier.

Another technique consists in equipping the front end of the turbojet with two counter-rotatable fans that are directly driven by coaxial drive shafts, said drive shafts also driving the counter-rotatable rotors of the low-pressure compressor for the main air flow.

French patents Nos. 2 560 642 and 2 603 644 describe a turbojet of that type. In those documents, the rear fan is disposed around the low-pressure compressor, immediately behind the front fan. Thus, the blades of the rear fan are adjacent to the blades of the front fan, which creates unwanted noise. Moreover, in the event of ingestion, the space between the two blade rings is insufficient to guarantee that the airfoils of the blades of the two fans do not touch one another on deforming.

French patent No. 2 603 343 also describes a turbojet having two counter-rotatable fans with the rotors of the low-pressure compressor being disposed axially between the two fans. That disposition leads to an excessive increase in the overhang of the low-pressure compressor at the front of the rear fan.

### OBJECTS AND SUMMARY OF THE INVENTION

The object of the invention is to provide a turbojet having two counter-rotatable fans, which turbojet complies with noise criteria and also enables the high-pressure compressor to be properly charged.

The invention achieves this object by the fact that the blades of the rear fan are disposed in the by-pass air flow and extend from a wheel that surrounds the low-pressure compressor, said low-pressure compressor having both an outer rotor driven by the rear fan rotary shaft that has a bore into which a plurality of rotor blade rings extend, and an inner rotor driven by the front fan rotary shaft that has a plurality of rotor blade rings extending out from its periphery, said rotor blade rings of the inner and outer rotary shafts alternating in the main air flow, and by the fact that the distance between the blades of the front fan and the blades of the rear fan is not less than twice the length of the projection onto the axis of the cord-line of the blades of the front fan.

Thus, to avoid lengthening the motor, the second fan is arranged in the vicinity of the compressor, radially outwardly, in the by-pass air flow.

Advantageously, the distance between the blades of the two fans is not less than 2.5 times the length of the projection onto the axis of the cord-line of the blades of the front fan.

More advantageously, the distance between the blades of the two fans is not less than 3.5 times the length of the projection onto the axis of the cord-line of the blades of the front fan.

Those values, above the values disclosed in FR 2 603 343 allow to improve noise criteria.

Preferably, the drive shafts are driven by two counter-rotatable low-pressure turbines.

### BRIEF DESCRIPTION OF THE DRAWINGS

Other characteristics and advantages of the invention appear on reading the following description given by way of example and with reference to the accompanying drawing, in which:

The sole FIGURE is a fragmentary half-section of the front end of a two-fan turbojet, in accordance with the invention.

### MORE DETAILED DESCRIPTION

The drawing is a fragmentary view of the front end of a turbojet of axis X having a front fan 3 and a rear fan 5 at the front of an intermediate casing, said front fan 3 being driven by an inner drive shaft 4, said rear fan 5 being driven by an intermediate drive shaft 6 coaxial with the inner shaft 4 and surrounding said inner shaft, and a low-pressure compressor 7 for compressing the air coming into the channel 8 for the primary or “main” air flow F1 and disposed axially between the front fan 3 and the intermediate casing 2.

The front fan 3 has blades 10 which extend from the periphery of a wheel 11 to a fan casing 12, said fan casing defining the outside of the channel 13 for the secondary or “by-pass” air F2.

The rear fan 5 likewise has blades 14 which extend from the periphery of a wheel 15 through the channel 13 for the by-pass air F2 to a fan casing 12. The wheel 15 is disposed radially outside the low-pressure compressor 7.

The wheel 11 of the front fan 3 is connected to the inner shaft 4 by a cone 16, whereas the wheel 15 of the rear fan 5 is connected to the intermediate shaft 6 by a cone 17 via a downstream ring 18 of rotor blades 19 in the low-pressure compressor 7.

The intermediate casing 2 presents an outer structural grid 30 in the by-pass air flow F2 and an inner structural grid 31 in the main air flow F1. The outer structural grid 30 is outwardly connected to the fan casing 12. An annular box 32 is interposed between the outer structural grid 30 and the inner structural grid 31.

The low-pressure compressor 7 has an outer rotor 20 that is secured to the wheel 15 of the rear fan 5, which wheel has a bore into which there extend radially inwards through the channel 8 both the downstream ring 18 of rotor blades 19 and a second ring of rotor blades 21 that is situated upstream from the downstream ring 18. Said low-pressure compressor also has an inner rotor 30 having, extending radially outwards from its periphery, both an upstream ring 31 of rotor blades 32 that is disposed upstream from the ring of rotor blades 21, and a ring 33 of rotor blades that is interposed between the rotor blades 21 of the second ring and the rotor blades 19 of the downstream ring 18. The inner rotor 30 is connected to the cone 16 or to the wheel 11 of the front fan by a bushing 35. At the front, the outer rotor 20 has a separating tip 25 for separating the main air flow F1 from the by-pass air flow F2.

The drive shafts 4 and 6 are rotated in opposite directions by two counter-rotatable turbines or, preferably, by a working turbine that has an inner rotor and an outer rotor, said two rotors having rotor blade rings in alternation along the axis of the turbine. This disposition reduces both the length and the weight of the working turbine because there is no stator.

The intermediate casing 2 supports the drive shaft 6 of the rear fan 5 and of the outer rotor 20 of the low-pressure compressor 7, via a thrust bearing 40 and a roller bearing 41, said intermediate casing also supporting the drive shaft 4 of the front fan 3 and of the inner rotor 30 of the low-pressure compressor 7 via an inter-shaft thrust bearing 42 that is situated under the roller bearing 41, and via an inter-shaft roller bearing 43 that is situated under the thrust bearing 40.

Reference 44 designates a thrust bearing that is interposed between the intermediate casing 2 and the drive shaft 50 of the high-pressure compressor 51 that is situated behind the intermediate casing 2.

The distance L between the blades 10 of the front fan 3 and the blades 14 of the rear fan 5 is long enough to comply with noise criteria.

Said distance L is not less than twice the length l of the projection onto the axis of the cord-line of the blades 10 of the front fan 3. Preferably, said distance L is not less than 2.5 times, even 3.5 times, said length l.

1. A three-spool by-pass turbojet with a high bypass ratio having a front fan (3) and a rear fan (5), at the front of a first intermediary casing (2), said fans having blades (10, 14) that extend radially outwards to the fan casing (12) defining the outside of the by-pass air flow (F2), and also a low-pressure compressor (7) for compressing the air coming into the channel (8) for the main air flow (F1), said front fan (3) and said rear fan (5) being rotated directly, and separately, by two counter-rotatable shafts (4, 6) that are coaxial, and said low-pressure compressor having two sets of counter-rotatable blade rings that are also driven by said shafts,
wherein the blades (14) of the rear fan (5) are disposed in the by-pass air (F2) and extend from a wheel (15) that surrounds the low-pressure compressor (7), said low-pressure compressor having both an outer rotor (20) driven by the rear fan rotary shaft (6) that has a bore into which a plurality of rotor blade (19, 21) rings extend, and an inner rotor (30) driven by the front fan rotary shaft (4) that has a plurality of rotor blade (32, 34) rings extending out from its periphery, said rotor blade rings of the inner and outer rotary shafts alternating in the main air flow (F1); and
wherein the distance (L) between the blades (10) of the front fan (3) and the blades (14) of the rear fan (5) is not less than twice the length (l) of the projection onto the axis of the cord-line of the blades (10) of the front fan (3).

2. A turbojet according to claim 1, wherein the distance (L) between the blades (10, 14) of the two fans (3, 5) is not less than 2.5 times the length (l) of the projection onto the axis of the cord-line of the blades (10) of the front fan (3).

3. A turbojet according to claim 2, wherein the distance (L) between the blades (10, 14) of the two fans (3, 5) is not less than 3.5 times the length (l) of the projection onto the axis of the cord-line of the blades (10) of the front fan (3).
